(19) United States
(12) Patent Application Publication
(10) Pub. No.: US 2002/0013171 A1
(43) Pub. Date: Jan. 31, 2002

(54) Service point management apparatus and service point management method enabling ready point management

(76) Inventor: Akihiro Akamatsu, Osaka-shi (JP)

Correspondence Address: BIRCH STEWART KOLASCH & BIRCH, PO BOX 747, FALLS CHURCH, VA, 22040-0747, US

(21) Appl. No.: 09/948,771

(22) Filed: Sep. 10, 2001

(30) Foreign Application Priority Data
May 9, 2000 (JP) 2000-135849 (P)
Sep. 12, 2000 (JP) 2000-276093 (P)

(51) Int. Cl. A63F 13/00

(52) U.S. Cl. 463/25; 463/1; 463/42

(57) ABSTRACT

A card for adding up service points is provided with a rewritable display part in addition to a display part for the name of a customer and a customer ID number. The rewritable display part displays the situation of accrual of service points in each chain and the total of the service points. The customer may not have individual cards for a plurality of chains. The customer can get a special favor such as a gift, for example, from each chain in exchange for the service points accrued in this chain or from a point bank in exchange for the total service points. The customer can also circulate the service points as virtual currency for settling his/her accounts.

### BACKGROUND OF THE INVENTION

1. Field of the Invention

The present invention relates to a service point management apparatus and a service point management method, and more particularly, it relates to a service point management apparatus and a service point management method recording service points accrued in a plurality of chain stores.

2. Description of the Prior Art

When a customer purchases a product or pays for any service in a shop, the shop issues a discount coupon or provides service points to be accrued. In the latter case, the shop issues a card to each customer for adding up the accrued service points as electronic information.

However, it is troublesome for the customer to carry discount coupons or cards corresponding to a plurality of shops.

### SUMMARY OF THE INVENTION

The present invention has been proposed in order to solve the aforementioned problem, and an object thereof is to provide a service point management apparatus and a service point management method convenient for a customer.

In order to attain the aforementioned object, a service point management apparatus according to an aspect of the present invention records the total of service points accrued in a chain and the total of all service points accrued in a plurality of chains every customer.

Preferably, the service point management apparatus further comprises means for transferring service points of a customer recorded in the service point management apparatus as additional service points for another customer.

Preferably, the service point management apparatus transfers the service points on the basis of the result of a game.

Preferably, the service point management apparatus further comprises means for increasing/decreasing the number of service points recorded in the service point management apparatus.

Preferably, the service point management apparatus increases/decreases the number of the service points on the basis of the result of a game.

According to another aspect of the present invention, a service point management method records the total of service points accrued in a chain and the total of all service points accrued in a plurality of chains every customer.

Preferably, the service point management method transfers recorded service points of a customer as additional service points for another customer.

Preferably, the service point management method transfers the service points on the basis of the result of a game.

Preferably, the service point management method increases/decreases the number of recorded service points.

Preferably, the service point management method increases/decreases the number of the recorded service points on the basis of the result of a game.

According to still another aspect of the present invention, a card records the total of service points accrued in a chain and the total of all service points accrued in a plurality of chains.

According to a further aspect of the present invention, a service point management apparatus records the total of service points accrued in a chain and the total of all service points accrued in a plurality of chains every customer and manages presentation of a gift in response to the number of the service points accrued by each customer.

According to a further aspect of the present invention, a service point management apparatus has a function of recording the total of service points accrued in a chain and the total of all service points accrued in a plurality of chains every customer and transmitting information on the service points accrued by each customer to a communicable apparatus such as a computer, a portable telephone, a portable terminal, a facsimile machine, a terminal set in any shop or the like through a communication line.

According to a further aspect of the present invention, a terminal unit receives the total of service points accrued in a chain by each customer and the total of all service points accrued in a plurality of chains through a communication line.

According to a further aspect of the present invention, a service point management method records the total of service points accrued in a chain and the total of all service points accrued in a plurality of chains every customer and manages presentation of a gift in response to the number of the service points accrued by each customer.

According to a further aspect of the present invention, a service point management method records the total of service points accrued in a chain and the total of all service points accrued in a plurality of chains every customer and transmits information on the service points accrued by each customer to a communicable apparatus such as a computer, a portable telephone, a portable terminal, a facsimile machine, a terminal set in any shop or the like through a communication line.

According to a further aspect of the present invention, a service point management method receives the total of service points accrued in a chain by each customer and the total of all service points accrued in a plurality of chains through a communication line.

According to a further aspect of the present invention, an electronic settlement system circulates service points managed every customer as virtual currency on a communication line for settling accounts.

According to a further aspect of the present invention, an electronic settlement method circulates service points managed every customer as virtual currency on a communication line for settling accounts.

According to a further aspect of the present invention, a service point management apparatus comprises first calculation means calculating the total of service points accrued in each chain and second calculation means calculating the total of results of calculation of the first calculation means.

According to a further aspect of the present invention, a service point management method comprises a first calculation step of calculating the total of service points accrued in each chain and a second calculation step of calculating the total of results of calculation in the first calculation step.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the structure of a service point management system according to an embodiment of the present invention;

FIG. 2 illustrates the structure of a LAN provided in a point bank 100;

FIG. 3 illustrates the structure of a LAN provided in a shop 200;

FIG. 4 illustrates information recorded in a server of the point bank 100;

FIG. 5 illustrates the appearance of a card issued to a customer; and

FIG. 6 is a diagram for illustrating a method of adding up service points accrued in respective chains.

### DESCRIPTION OF THE PREFERRED EMBODIMENTS

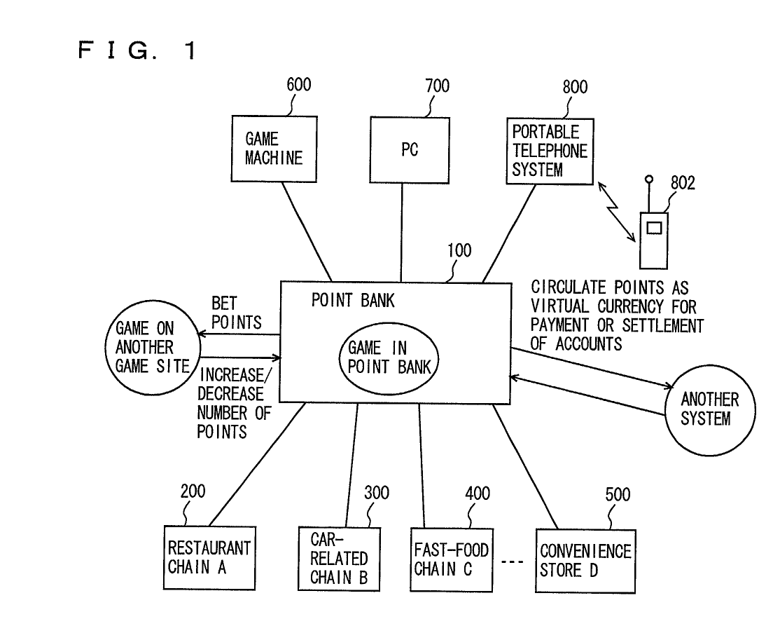

Referring to FIG. 1, a service point management system according to an embodiment of the present invention is formed by a point bank 100 adding up, increasing/decreasing, transferring and circulating service points, a plurality of shops 200 to 500 connected to the point bank 100 through an electric communication line such as the Internet, a game machine 600 and a personal computer 700 set in the house of a customer or a game arcade and a portable telephone system 800.

According to this embodiment, service points accrued by the customer can be employed as virtual currency in another system. In other words, the customer can make payment with the service points.

The shops 200 to 500 may belong to the same group, or the types thereof may be absolutely different from each other. In other words, the shops 200 to 500 may be economically related to each other through a capital tie-up or the like, or affiliated to absolutely different groups. The shops 200 to 500 are members of a service point management group employing the service point management system according to this embodiment.

It is assumed that the shop 200 belongs to a restaurant chain A, the shop 300 belongs to a car-related chain B, the shop 400 belongs to a fast-food chain C and the shop 500 is a convenience store D.

When the customer shops or pays for service in any of the shops 200 to 500, service points responsive to the amount of payment are added to a computer provided in the point bank 100 in the service point management system according to this embodiment. Such service points are totaled for each of the shops 200 to 500. The sum of the service points totaled for the respective shops 200 to 500 is recorded as the grand total.

The customer can confirm the number of the accrued service points through the game machine 600, the personal computer 700 or his/her portable terminal 802. Further, the customer can play a game for his/her service points through the game machine 600. The game may be a match or an individual game such as a slot machine. Service points are transferred from a customer to another customer or the number of service points is increased/decreased on the basis of the result of the game.

The customer can play a game prepared in the point bank 100 or a game on another site for his/her service points by gaining access from the personal computer 700 or a portable telephone.

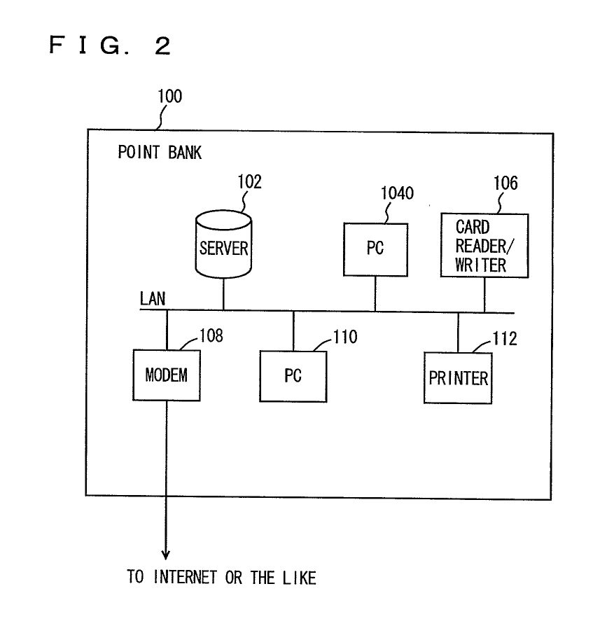

FIG. 2 illustrates the structure of a LAN provided in the point bank 100.

Referring to FIG. 2, a server 102 managing and totaling service points, personal computers 104 and 110, a card reader/writer 106, a modem 108 and a printer 112 are connected to the LAN. This system can be connected to a communication line such as the Internet through the modem 108.

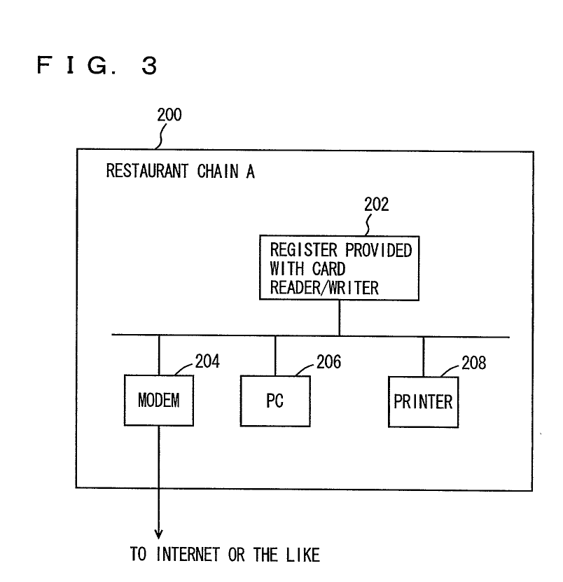

FIG. 3 illustrates the structure of a LAN provided in the shop 200.

Referring to FIG. 3, a personal computer 206, a register 202 provided with a card reader/writer, a modem 204 and a printer 208 are connected to the LAN. The LAN can be connected to a communication line such as the Internet through the modem 204.

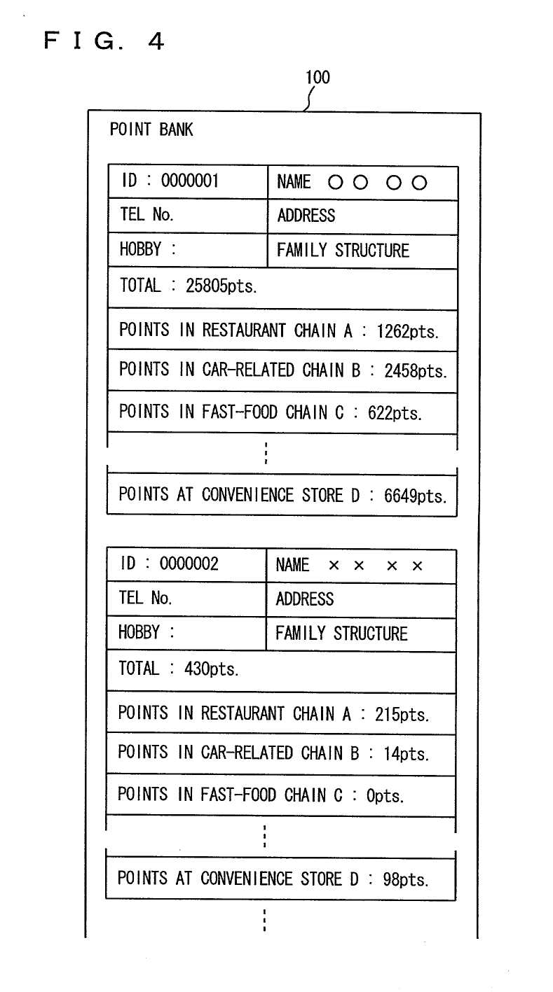

FIG. 4 illustrates information recorded in the server 102 of the point bank 100.

Referring to FIG. 4, a customer ID number is supplied to each customer, and data such as the name, the telephone number, the address, the hobby and the family structure (as well as the age etc.) of the customer are recorded in the server 102.

The service points added up in the plurality of shops 200 to 500 respectively and the total thereof are recorded every customer. The customer ID number may be replaced with the number of the customer's portable telephone. The customer can access this service point information at any time through the personal computer 700, the portable telephone, a PDA (personal digital assistant), a facsimile machine or a terminal set in any of the shops 200 to 500.

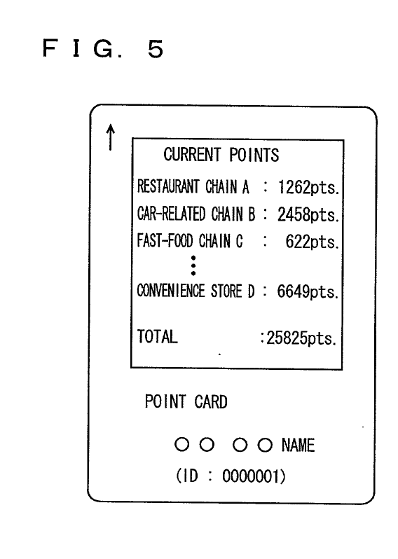

FIG. 5 illustrates the appearance of a card issued to the customer.

As shown in FIG. 5, the card comprises a rewritable display part in addition to a display part for the name of the customer and the customer ID number. The rewritable display part displays the situation of accrual of service points in the respective shops 200 to 500 and the total of the service points.

The customer can get a special favor such as a gift, for example, from each shop in exchange for the service points accrued in this shop or from the point bank 100 in exchange for the total of the service points.

The customer may not have a number of cards issued from the plurality of shops 200 to 500, whereby convenience for the customer is improved.

Further, the customer can play a game for his/her service points with great pleasure. It is effective to manage the terms of validity of the service points in the system and show the same to the user through a display of the portable telephone or the like.

The service points accrued in each shop belonging to each chain, the total of service points accrued in each chain and the total of service points accrued in a plurality of chains affiliated to the service point management group may be recorded in the server of the point bank 100 every customer.

In other words, the service points accrued in each shop belonging to each chain are recorded and the total of service points accrued in each chain is calculated and recorded so that the results of such calculation are totaled and recorded in relation to all chains.

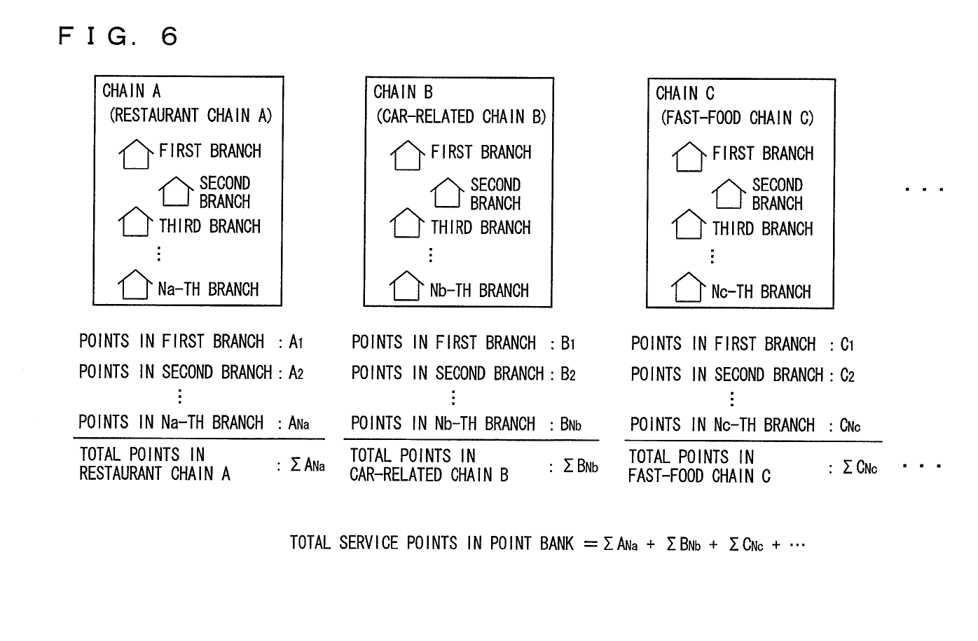

Referring to FIG. 6, it is assumed that the chains A, B and C are affiliated to the service point management group. It is also assumed that the chains A, B and C have Na, Nb and Nc branches respectively.

The server of the point bank 100 first records service points A₁, A₂, . . . , A_{Na}, B₁, B₂, . . . , B_{Nb} and C₁, C₂, . . . , C_{Nc} accrued in the respective branches belonging to the chains A, B and C every customer. Then, the server calculates and records total points (totals of the service points) ΣA_{Na}, ΣB_{Nb} and ΣC_{Nc} accrued in the chains A, B and C respectively. The total points ΣA_{Na}, ΣB_{Nb} and ΣC_{Nc} correspond to the data recorded in the columns of the points in the restaurant chain A, the car-related chain B and the fast-food chain C shown in FIG. 4.

The server further calculates the sum of the total points ΣA_{Na}, ΣB_{Nb} and ΣC_{Nc} as the grand total service points in the point bank 100 and records the same as the grand total of the service points accrued in all chains A, B and C affiliated to the service point management group. This grand total corresponds to the data of the total points shown in FIG. 4.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A service point management apparatus recording the total of service points accrued in a chain and the total of all service points accrued in a plurality of chains every customer.

2. The service point management apparatus according to claim 1, further comprising means for transferring service points of a customer recorded in said service point management apparatus as additional service points for another customer.

3. The service point management apparatus according to claim 2, transferring said service points on the basis of the result of a game.

4. The service point management apparatus according to claim 1, further comprising means for increasing/decreasing the number of service points recorded in said service point management apparatus.

5. The service point management apparatus according to claim 4, increasing/decreasing the number of said service points on the basis of the result of a game.

6. A service point management method recording the total of service points accrued in a chain and the total of all service points accrued in a plurality of chains every customer.

7. The service point management method according to claim 6, transferring recorded service points of a customer as additional service points for another customer.

8. The service point management method according to claim 7, transferring said service points on the basis of the result of a game.

9. The service point management method according to claim 6, increasing/decreasing the number of recorded service points.

10. The service point management method according to claim 9, increasing/decreasing the number of said recorded service points on the basis of the result of a game.

11. A card recording the total of service points accrued in a chain and the total of all service points accrued in a plurality of chains.

12. A service point management apparatus recording the total of service points accrued in a chain and the total of all service points accrued in a plurality of chains every customer and managing presentation of a gift in response to the number of said service points accrued by each customer.

13. A service point management apparatus having a function of recording the total of service points accrued in a chain and the total of all service points accrued in a plurality of chains every customer and transmitting information on said service points accrued by each customer to a communicable apparatus such as a computer, a portable telephone, a portable terminal, a facsimile machine, a terminal set in any shop or the like through a communication line.

14. A terminal unit receiving the total of service points accrued in a chain by each customer and the total of all service points accrued in a plurality of chains through a communication line.

15. A service point management method recording the total of service points accrued in a chain and the total of all service points accrued in a plurality of chains every customer and managing presentation of a gift in response to the number of said service points accrued by each customer.

16. A service point management method recording the total of service points accrued in a chain and the total of all service points accrued in a plurality of chains every customer and transmitting information on said service points accrued by each customer to a communicable apparatus such as a computer, a portable telephone, a portable terminal, a facsimile machine, a terminal set in any shop or the like through a communication line.

17. A service point management method receiving the total of service points accrued in a chain by each customer and the total of all service points accrued in a plurality of chains through a communication line.

18. An electronic settlement system circulating service points managed every customer as virtual currency on a communication line for settling accounts.

19. An electronic settlement method circulating service points managed every customer as virtual currency on a communication line for settling accounts.

20. A service point management apparatus comprising:
first calculation means calculating the total of service points accrued in each chain; and
second calculation means calculating the total of results of calculation of said first calculation means.

21. A service point management method comprising:
a first calculation step of calculating the total of service points accrued in each chain; and
a second calculation step of calculating the total of results of calculation in said first calculation step.
